(19) United States
(12) Patent Application Publication
(10) Pub. No.: US 2024/0149517 A1
(43) Pub. Date: May 9, 2024

(54) BLOW MOLDED ARTICLES INCORPORATING POST-CONSUMER RESIN AND METHODS THEREOF

(71) Applicant: Braskem S.A., Camaçari (BR)

(72) Inventors: Gabriel Degues Müller, São Paulo (BR); Leandro de Castro Tomasi, São Paulo (BR)

(73) Assignee: Braskem S.A., Camaçari (BR)

(21) Appl. No.: 17/769,674

(22) PCT Filed: Oct. 15, 2020
(86) PCT No.: PCT/IB2020/020063

§ 371 Date: Apr. 15, 2022

Related U.S. Application Data
(60) Provisional application No. 62/915,496, filed on Oct. 15, 2019.

(51) Int. Cl. B29C 49/00; C08L 23/06; B29K 23/00; B29K 105/26

(52) U.S. Cl. CPC B29C 49/0005; C08L 23/06; B29K 2023/0625; B29K 2023/0633; B29K 2023/065; B29K 2023/083; B29K 2105/26; C08L 2205/025; C08L 2207/066; C08L 2207/20

(57) ABSTRACT

A blow molded article may include at least one layer comprising a blended ethylene-based polymer composition, the blended ethylene-based having a PCR content varying from greater than 10 wt % to less than 95 wt % and a virgin resin content varying from greater than 5 to less than 90 wt %, wherein the virgin resin is selected from HOPE, LLDPE, LDPE, EVA, or combinations thereof, wherein the PCR and virgin content are selected so that the blended ethylene-based polymer composition has an Izod impact strength at 23° C., as measured according to ASTM D 256, of at least 50 J/m, and/or a flexural modulus at 1% secant, as measured according to ASTM D 790, ranging from about 800 to 1700 MPa.

### BACKGROUND

Polyolefins such as polyethylene (PE) and polypropylene (PP) may be used to manufacture a varied range of articles, including films, molded products, foams, and the like. Polyolefins may have characteristics such as high processability, low production cost, flexibility, low density and recycling possibility. While plastics such as polyethylene have many beneficial uses, production and manufacture of plastics and plastic articles often impacts the environment in detrimental ways including trash production and increased emission of CO₂ during processing.

One of the largest challenges faced by society today is to reduce greenhouse gas emissions in order to minimize the impact on the climate and environment. International agreements such as the Paris Agreement of 2015 may set limits on CO₂ emissions and drive the transition to a low carbon economy based on renewable energy, in addition to the development of new economic and business models. In some cases, new production techniques and material solutions may be used to reduce the carbon footprint during plastic manufacture, and a life cycle perspective may be applied to weight the possible trade-offs between material functionality and environmental impact.

Another great challenge of the society is to rethink the use of plastics in order to reduce the environmental impact of the waste residues. One of the options is to mechanically recycle the consumed plastic to reintroduce it in the plastic value chain. Post-consumer resins (PCR) are available in the market, but because of the high inhomogeneity of sources and the chemical and mechanical damages that the plastic suffers in its entire chain (from the production to the waste), the properties of those resins are generally poor, being a challenge to reuse them in many applications that require high property standards.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a blow molded article that includes at least one layer comprising a blended ethylene-based polymer composition, the blended ethylene-based having a PCR content varying from greater than 10 wt % to less than 95 wt % and a virgin resin content varying from greater than 5 to less than 90 wt %, wherein the virgin resin is selected from HDPE, LLDPE, LDPE, EVA, or combinations thereof, wherein the PCR and virgin content are selected so that the blended ethylene-based polymer composition has an Izod impact strength at 23° C., as measured according to ASTM D 256, of at least 50 J/m, and/or a flexural modulus at 1% secant, as measured according to ASTM D 790, ranging from about 800 to 1700 MPa.

In another aspect, embodiments disclosed herein relate to a method for preparing blow molded article that includes at least one layer comprising a blended ethylene-based polymer composition, the blended ethylene-based having a PCR content varying from greater than 10 wt % to less than 95 wt % and a virgin resin content varying from greater than 5 to less than 90 wt %, wherein the virgin resin is selected from HDPE, LLDPE, LDPE, EVA, or combinations thereof, wherein the PCR and virgin content are selected so that the blended ethylene-based polymer composition has an Izod impact strength at 23° C., as measured according to ASTM D 256, of at least 50 J/m, and/or a flexural modulus at 1% secant, as measured according to ASTM D 790, ranging from about 800 to 1700 MPa, where the method includes dry blending the PCR and the virgin resin selected from HDPE, LDPE, EVA, LLDPE or combinations thereof to form the blended ethylene-based polymer composition; and blow molding the article.

In another aspect, embodiments disclosed herein relate to a method for preparing a blow molded article that includes at least one layer comprising a blended ethylene-based polymer composition, the blended ethylene-based having a PCR content varying from greater than 10 wt % to less than 95 wt % and a virgin resin content varying from greater than 5 to less than 90 wt %, wherein the virgin resin is selected from HDPE, LLDPE, LDPE, EVA, or combinations thereof, wherein the PCR and virgin content are selected so that the blended ethylene-based polymer composition has an Izod impact strength at 23° C., as measured according to ASTM D 256, of at least 50 J/m, and/or a flexural modulus at 1% secant, as measured according to ASTM D 790, ranging from about 800 to 1700 MPa, where the method includes melt blending the PCR and the virgin resin selected from HDPE, LDPE, EVA, LLDPE or combinations thereof to form the blended ethylene-based polymer composition; and blow molding the article.

In yet another aspect, embodiments disclosed herein relate to use of an ethylene-based polymer composition comprising a blend of PCR with a virgin resin selected from HDPE, LDPE, LLDPE and/or EVA to form a blow molded article that includes at least one layer comprising a blended ethylene-based polymer composition, the blended ethylene-based having a PCR content varying from greater than 10 wt % to less than 95 wt % and a virgin resin content varying from greater than 5 to less than 90 wt %, wherein the virgin resin is selected from HDPE, LLDPE, LDPE, EVA, or combinations thereof, wherein the PCR and virgin content are selected so that the blended ethylene-based polymer composition has an Izod impact strength at 23° C., as measured according to ASTM D 256, of at least 50 J/m, and/or a flexural modulus at 1% secant, as measured according to ASTM D 790, ranging from about 800 to 1700 MPa.

Other aspects and advantages of the claimed subject matter will be apparent from the following description and the appended claims.

### DETAILED DESCRIPTION

In one aspect, embodiments disclosed herein relate to blow molded articles that contain blended polymer compositions (based on polyethylene in particular) that may exhibit a reduction in carbon emissions and overall potential environmental impact when compared to equivalent materials produced using exclusively virgin and/or exclusively fossil fuel sources. In particular, the production of such blow molded articles may have a mono- or multilayer structure that incorporates, in at least one of the layers, an ethylene-based polymer composition that is combination or blend of post-consumer resin (PCR) with a virgin resin of high density polyethylene (HDPE), linear low density polyethylene (LLDPE) and/or low density polyethylene (LDPE) and/or ethylene vinyl acetate (EVA). In one or more particular embodiments, the HPDE, LLDPE, LDPE, and/or EVA in the ethylene-based polymer compositions (including the blended compositions) is a virgin biobased resin, but other embodiments are directed to a virgin petrochemical resin.

The blow molded articles may be, in one or more embodiments, a structure with two, three, or more layers. In particular embodiments, the blow molded articles may be a trilayer structure, which comprises a core layer between an inner layer and an outer layer. Reference to inner layer and outer layer is relative to the blow molding process (for example, in blow molding a bottle, the inner layer is exposed to the interior of the bottle and the outer layer is exposed to the outside environment).

In the event of multiple inner or outer layers, such layers may be referred to as a first inner or innermost layer and second inner layer, and first outer or outermost layer and second outer layer.

Generally, the single layer or each of the layers (in a multilayer blow molded structure) may be formed from ethylene-based resin(s) (i.e., is an ethylene-based polymer composition), having a PCR content ranging from 10 to 95 wt % of the respective layer and a virgin resin content ranging from 5 to 90 wt % of the respective layer, where the virgin resin is selected from the group consisting of HDPE, LLDPE, LDPE, EVA, and combinations thereof. In accordance with one or more embodiments of the present disclosure, at least one of the layers is formed from an ethylene-based polymer composition that includes a blend of PCR and virgin resin (HDPE, LLDPE, LDPE, and/or EVA). Given that each layer comprises an ethylene-based composition, the layer that contains both PCR and virgin resin is referred to as a “blended ethylene-based polymer composition.”

Virgin Resin

Virgin resin may be present in any layer of the blow molded article, or alternatively, when in monolayer structure, it is at least present in the blended ethylene-based polymer composition. The virgin resin (in any layer, including, but not limited to the blended ethylene-based polymer composition) may be selected from HDPE, LLDPE, LDPE, and/or EVA.

The HDPE and/or LLDPE and/or LDPE can be a homopolymer of ethylene or contain small amounts of comonomer selected from an alpha olefin containing 3 to 10 carbon atoms, preferably 4 to 10 carbon atoms. In these instances, the LLDPE, LDPE and HDPE polymers may contain greater than 95% of its weight as ethylene units.

For embodiments using EVA, EVA copolymers incorporating various ratios of ethylene and vinyl acetate. In one or more embodiments, the percent by weight of ethylene in the EVA polymer ranges from a lower limit selected from one of 55 wt %, 60 wt %, 65 wt %, and 70 wt %, to an upper limit selected from one of 70 wt %, 80 wt %, 85 wt %, 92 wt %, and 95 wt %, where any lower limit may be paired with any upper limit. The percent by weight of vinyl acetate content as determined by ASTM D5594 in the EVA may range from a lower limit selected from one of 5 wt %, 8 wt %, 12 wt %, 15 wt %, 20 wt % to an upper limit selected from 25 wt %, 30 wt %, 35 wt %, and 40 wt %, where any lower limit may be paired with any upper limit.

While one or more embodiments may use a petrochemical HDPE, LLDPE, LDPE, and/or EVA virgin resin in the ethylene-based polymer compositions (in any layer of the molded article), in one or more particular embodiments, the virgin resin may be bio-based. In particular embodiments using a blend of biobased resin and PCR, the ethylene-based polymer composition may have a particularly low carbon emission (or even a carbon uptake) through the selection of the amounts of the two components in the blended composition.

Biobased ethylene polymers (HDPE, LLDPE, LDPE, and/or EVA) in accordance with the present disclosure may include polyolefins containing a weight percentage of biologically derived monomers. Biobased ethylene polymers and monomers that are derived from natural products may be distinguished from polymers and monomers obtained from fossil-fuel sources (also referred to as petroleum-based polymers). Because biobased materials are obtained from sources that actively reduce CO₂ in the atmosphere or otherwise require less CO₂ emission during production, such materials are often regarded as “green” or renewable. The use of products derived from natural sources, as opposed to those obtained from fossil sources, has increasingly been widely preferred as an effective means of reducing the increase in atmospheric carbon dioxide concentration, therefore effectively limiting the expansion of the greenhouse effect. Products thus obtained from natural raw materials have a difference, relative to fossil sourced products, in their renewable carbon contents. This renewable carbon content can be certified by the methodology described in the technical ASTM D 6866-18 Norm, “Standard Test Methods for Determining the Biobased Content of Solid, Liquid, and Gaseous Samples Using Radiocarbon Analysis”. Products obtained from renewable natural raw materials have the additional property of being able to be incinerated at the end of their life cycle and only producing CO₂ of a non-fossil origin.

Examples of biobased ethylene-based polymers may include polymers generated from ethylene derived from natural sources such as sugarcane and sugar beet, maple, date palm, sugar palm, sorghum, American agave, starches, corn, wheat, barley, sorghum, rice, potato, cassava, sweet potato, algae, fruit, citrus fruit, materials comprising cellulose, wine, materials comprising hemicelluloses, materials comprising lignin, cellulosics, lignocelluosics, wood, woody plants, straw, sugarcane bagasse, sugarcane leaves, corn stover, wood residues, paper, polysaccharides such as pectin, chitin, levan, pullulan, and the like, and any combination thereof.

Biobased materials may be processed by any suitable method to produce ethylene, such as the production of ethanol from sugarcane, and the subsequent dehydration of ethanol to ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Biologically sourced ethanol, known as bio-ethanol, used to produce ethylene may be obtained by the fermentation of sugars derived from cultures such as that of sugar cane and beets, or from hydrolyzed starch, which is, in turn, associated with other materials such as corn. It is also envisioned that the biobased ethylene may be obtained from hydrolysis based products from cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

Further, in the case of biobased EVA, in addition to (or instead of) a renewable source of ethylene, it is also possible to use a biobased vinyl acetate. In particular embodiments, at least a portion of the ethylene and/or at least a portion of the vinyl acetate are from renewable sources.

Bio-based vinyl acetate may be produced by producing acetic acid by oxidation of ethanol (which may be formed as described above) followed by reaction of ethylene and acetic acid to acyloxylate the ethylene and arrive at vinyl acetate. Further, it is understood that the ethylene reacted with the acetic acid may also be formed from a renewable source as described above. For example, a renewable starting material, including those described above, may be fermented and optionally purified, in order to produce at least one alcohol (either ethanol or a mixture of alcohols including ethanol). The alcohol may be separated into two parts, where the first part is introduced into a first reactor and the second part may be introduced into a second reactor. In the first reactor, the alcohol may be dehydrated in order to produce an alkene (ethylene or a mixture of alkenes including ethylene, depending on whether a purification followed the fermentation) followed by optional purification to obtain ethylene. One of ordinary skill in the art may appreciate that if the purification occurs prior to dehydration, then it need not occur after dehydration, and vice versa. In the second reactor, the alcohol may be oxidized in order to obtain acetic acid, which may optionally be purified. In a third reactor, the ethylene produced in the first reactor and the acetic acid produced in the second reactor may be combined and reacted to acyloxylate the ethylene and form vinyl acetate, which may be subsequently isolated and optionally purified. Additional details about oxidation of ethanol to form acetic acid may be found in U.S. Pat. No. 5,840,971 and Selective catalytic oxidation of ethanol to acetic acid on dispersed Mo—V-Nb mixed oxides. Li X, Iglesia E. Chemistry. 2007; 13(33):9324-30. Alternatively, acetic acid may be obtained from a fatty acid, as described in “The Production of Vinyl Acetate Monomer as a Co-Product from the Non-Catalytic Cracking of Soybean Oil”, Benjamin Jones, Michael Linnen, Brian Tande and Wayne Seames, Processes, 2015, 3, 61-9-633. Further, the production of acetic acid from fermentation performed by acetogenic bacteria, as described in “Acetic acid bacteria: A group of bacteria with versatile biotechnological applications”, Saichana N, Matsushita K, Adachi O, Frébort I, Frebortova J. Biotechnol Adv. 2015 Nov. 1; 33(6 Pt 2):1260-71 and Biotechnological applications of acetic acid bacteria. Raspor P, Goranovic D.Crit Rev Biotechnol. 2008; 28(2):101-24. Further, it is also understood that while some of the above description is directed to the formation of vinyl acetate, the production of ethylene used to produce vinyl acetate can also be used to form the ethylene that is subsequently reacted with the vinyl acetate to form the EVA copolymer of the present disclosure. Thus, for example, the amount of ethanol that is fed to the first and second reactors, respectively, may be vary depending on the relative amounts of ethylene and vinyl acetate being polymerized.

In one or more embodiments, biobased products obtained from natural materials may be certified as to their renewable carbon content, according to the methodology described in the technical standard ASTM D 6866-18, “Standard Test Methods for Determining the Biobased Content of Solid, Liquid, and Gaseous Samples Using Radiocarbon Analysis.”

Biobased resins (including biobased HDPE, biobased LLDPE, biobased LDPE, and biobased EVA) in accordance with the present disclosure may include an ethylene-containing resin having biobased carbon content as determined by ASTM D6866-18 Method B of at least 5%, or having a lower limit of any of 5%, 10%, 15%, 25%, 40% and 50% and an upper limit selected from any of 60%, 75%, 90%, 98%, and 100%, where any lower limit may be combined with any upper limit.

In one or more embodiments, one or more of the ethylene-based polymer compositions includes an HDPE and/or LLDPE and/or LDPE (which may optionally be biobased) that has a melt index measured according to ASTM D1238 at 190° C./2.16 kg ranging from 0.1 to 5 g/10 min. In particular, the melt index may have a lower limit ranging from any of 0.1, 0.2, or 0.3 g/10 min to an upper limit ranging from any of 0.4, 0.5, 1, 2, 3, 4, or 5 g/10 min, where any lower limit can be used in combination with any upper limit.

In one or more embodiments, one or more of the ethylene-based polymer compositions includes an HDPE and/or LLDPE and/or LDPE (which may optionally be biobased) that has a melt index measured according to ASTM D1238 at 190° C./21.6 kg ranging from 1 to 55 g/10 min. In particular, the melt index may have a lower limit of any of 1, 5, 10, 15, or 20 g/10 min and an upper limit of any of 30, 35, 40, 50, or 55 g/10 min, where any lower limit can be used in combination with any upper limit.

In one or more embodiments, one or more of the ethylene-based polymer compositions includes an EVA (which may optionally be biobased) that has a melt index measured according to ASTM D1238 at 190° C./2.16 kg ranging from 0.2 to 25 g/10 min. In particular, the melt index may have a lower limit ranging from any of 0.2, 0.3, 0.5, 1, or 2 g/10 min to an upper limit ranging from any of 5, 10, 15, 20, or 25 g/10 min, where any lower limit can be used in combination with any upper limit.

In one or more embodiments, one or more of the ethylene-based polymer compositions includes an HDPE (which may optionally be biobased) that has a density measured according to ASTM D 792 greater than 0.940 g/cm³. In particular, the density may range from a lower limit of any of 0.940, 0.945, and 0.950 g/cm³ to an upper limit of any of 0.960, 0.965, and 0.970 g/cm³, where any lower limit can be used in combination with any upper limit.

In one or more embodiments, one or more of the ethylene-based polymer compositions includes an LDPE and/or LLDPE (which may optionally be biobased) that has a density measured according to ASTM D 792 ranging from 0.915 to 0.930 g/cm³. In particular, the density may range from a lower limit of any of 0.910, 0.915, and 0.920 g/cm³, to an upper limit of any of 0.930, 0.935, and 0.940 g/cm³, where any lower limit can be used in combination with any upper limit.

In one or more embodiments, one or more of the ethylene-based polymer compositions includes an HDPE and/or LDPE and/or EVA and/or LLDPE (which may optionally be biobased) that has a tensile strength at yield measured according to ASTM D 638 (using a 2 mm thickness compression molded plaques prepared according to ASTM D4703) ranging from 10 to 45 MPa. In particular, the tensile strength at yield may range from a lower limit of any of 5, 10, 15, 20, or 25 MPa to an upper limit of any of 25, 30, 35, 40, or 45 MPa, where any lower limit can be used in combination with any upper limit.

In one or more embodiments, one or more of the ethylene-based polymer compositions includes an HDPE and/or LDPE and/or EVA and/or LLDPE (which may optionally be biobased) that has a tensile strength at break measured according to ASTM D 638 (using a 2 mm thickness compression molded plaques prepared according to ASTM D4703) ranging from 5 to 45 MPa. In particular, the tensile strength may range from a lower limit of any of 5, 10, 15, 20, or 25 MPa to an upper limit of any of 25, 30, 35, 40, or 45 MPa, where any lower limit can be used in combination with any upper limit.

In one or more embodiments, one or more of the ethylene-based polymer compositions includes an HDPE and/or LLDPE and/or LDPE and/or EVA (which may optionally be biobased) that has a flexural modulus at 1% secant, measured according to ASTM D 790 (using a 3 mm thickness compression molded plaques prepared according to ASTM D4703) ranging from 200 to 1700 MPa. In particular, the flexural modulus may have a lower limit ranging from any of 200, 500, 1000, or 1300 to an upper limit of any of 1400, 1500, 1600, 1700, or 1800 MPa, where any lower limit can be used in combination with any upper limit.

In one or more embodiments, one or more of the ethylene-based polymer compositions includes an HDPE and/or LLDPE and/or LDPE (which may optionally be biobased) that has an environmental stress cracking resistance, measured according to ASTM D 1693 Condition B, that is greater than 8 hours to 50% failure. In particular, the environmental stress cracking resistance may be greater than 8 hours, 10 hours, 20 hours or 30 hours to 50% failure.

In one or more embodiments, one or more of the ethylene-based polymer compositions includes an HDPE and/or LLDPE and/or LDPE (which may optionally be biobased) that has an environmental stress cracking resistance, measured according to ASTM D 1693 Condition C, that is greater than 15 hours to 50% failure. In particular, the environmental stress cracking resistance may be greater than 40 hours, 50 hours, 60 hours, or 70 hours to 50% failure.

In one or more embodiments, one or more of the ethylene-based polymer compositions includes an HDPE and/or LLDPE and/or LDPE and/or EVA (which may optionally be biobased) that has a Shore D hardness, measured according to ASTM D 2240, ranging from 45 to 70 Shore D. In particular, the Shore D hardness may have a lower limit of any of 45, 50, 55, or 60 Shore D to an upper limit of any of 60, 65, or 70 Shore D, where any lower limit can be used in combination with any upper limit.

In one or more embodiments, one or more of the ethylene-based polymer compositions includes an HDPE and/or LLDPE and/or LDPE and/or EVA (which may optionally be biobased) that has a heat deflection temperature, measured according to ASTM D648 under a load at 0.455 MPa (using a 3 mm thickness compression molded plaques prepared according to ASTM D4703), ranging from 40 to 80° C. In particular, the heat deflection temperature may have a lower limit of any of 40, 50, or 60° C. to an upper limit of any of 60, 70, or 80° C., where any lower limit can be used in combination with any upper limit.

In one or more embodiments, one or more of the ethylene-based polymer compositions includes an HDPE and/or LLDPE and/or LDPE and/or EVA (which may optionally be biobased) that has a Vicat softening temperature, measured according to ASTM D1525 at ION (using a 3 mm thickness compression molded plaques prepared according to ASTM D4703), that is greater than 80° C.

Post-Consumer Resin

PCR may be present in any layer of the blow molded article, but in accordance with one or more embodiments, it is at least present in the blended ethylene-based polymer composition.

In one or more embodiments, the PCR present in the one or more ethylene-based polymer compositions may be an ethylene-based PCR. PCR (post-consumer resin) refers to resin that is recycled after consumer use thereof. Generally, PCR may include resins having been used in rigid applications (such as PCR from previously blow molded articles, normally from 3D-shaped articles) as well as in flexible applications (such as from films). In one or more particular embodiments, the PCR used in the one or more ethylene-based polymer compositions may include PCR originally used in rigid applications. In particular, one or more embodiments of the present disclosure utilize HDPE PCR obtained from blow molded articles such as lubricant oil bottles. Often, such PCR may have a high amount of HDPE, though with the recycling process, it is understood that impurities may be present and that the material source may include a rigid LDPE or HDPE. Thus, it is understood that the PCR may be a mixture of polyethylenes, but is commonly predominantly HDPE. Further, it is also envisioned that the PCR may include recycled EVA, which may be particularly used when one or more of the ethylene-based polymer compositions includes a virgin EVA resin.

In one or more embodiments, one or more of the ethylene-based polymer compositions includes a PCR that has a melt index measured according to ASTM D1238 at 190° C./2.16 kg ranging from 0.10 to 1 g/10 min. In particular, the melt index may have a lower limit ranging from any of 0.10, 0.20, 0.30, to 0.40 g/10 min to an upper limit of any of 0.40, 0.60, or 1 g/10 min, where any lower limit can be used in combination with any upper limit.

In one or more embodiments, one or more of the ethylene-based polymer compositions includes a PCR that has a density measured according to ASTM D 792 greater than 0.940 g/cm³. In particular, the density may have a lower limit of any of 0.940, 0.950, or 0.960 g/cm³.

Blended Ethylene-Based Polymer Composition

As mentioned above, one or more of the ethylene-based polymer compositions includes a blend of virgin resin and PCR, and may be referred to as the blended ethylene-based polymer composition.

In one or more embodiments, blended polymer compositions, containing both virgin resin and PCR, may contain a percent by weight, based on the total composition (wt %) of the blend, a virgin resin (HDPE and/or LLDPE and/or LDPE and/or EVA, any of which may optionally be biobased) ranging from a lower limit selected from one of 1 wt %, 2.4 wt %, 5 wt %, 7.5 wt %, 10 wt %, 15 wt %, and 20 wt % to an upper limit selected from one of 30 wt %, 40 wt %, 50 wt % wt %, 59.3 wt %, 85 wt %, and 90 wt % where any lower limit can be used with any upper limit. In one or more particular embodiments, the blended ethylene-based polymer composition may comprise a virgin HDPE in an amount ranging from 2.4 wt % to 59.3 wt %. Further, it is envisioned that a polymer composition may contain more or less biobased ethylene-based polymers depending on the application and the desired carbon emission profile, discussed below.

In one or more embodiments, the blended ethylene-based polymer compositions may contain a percent by weight, based on the total composition (wt %) of the blend, a PCR content ranging from a lower limit selected from one of 10 wt %, 15 wt %, 20 wt %, 30 wt %, 40 wt %, 50 wt %, and 60 wt % to an upper limit selected from one of 60 wt %, 70 wt %, 80 wt % wt %, 90 wt %, 95 wt %, and 99 wt %, where any lower limit can be used with any upper limit. Further, it is envisioned that a polymer composition may contain more or less PCR depending on the application and the desired carbon emission profile.

In one or more embodiments, methods of blended polymer composition manufacture may exhibit carbon emission close to zero mass equivalents of CO₂ per mass of polymer (i.e., kg CO₂/kg polymer). In some embodiments, the mass equivalents of CO₂ per mass of a polymer composition may be negative, indicating a carbon uptake (also referred as carbon sequestration) of CO₂ from the atmosphere. Blended polymer compositions in accordance with the present disclosure may include a mixture of a biobased polymer composition (biobased HDPE, LDPE, LLDPE, and/or EVA) and a recycled polymer composition (such as PCR), where the amount of each component is selected based on the calculated carbon footprint as determined by an “Emission Factor” calculated as shown in Eq. 1:

P1_{Biobased}·Emission factor_{P1Biobased}+P2_{Recycled}·Emission factor_{P2Recycled}+P3_{Petro}·Emission factor_{P3Petro}=Emission factor_{blend} (1)

wherein P1_{Biobased} is the weight percentage of the biobased HDPE, biobased LLDPE, biobased LDPE, and/or biobased EVA, P2_{Recycled} is the weight percent of the PCR, and P3_{Petro} is the weight percent of the virgin petrochemical based HDPE, petrochemical based LDPE, petrochemical based EVA or petrochemical based LLDPE; Emission factor_{P1Biobased} is the calculated emission for the biobased HDPE, biobased LLDPE, biobased LDPE, and/or biobased EVA in kg CO₂/kg PE, Emission factor_{P2Recycled} is the calculated emission for the PCR in kg CO₂/kg PE, Emission factor_{P3Petro} is the calculated emission for the virgin petrochemical based HDPE, petrochemical based LDPE, petrochemical based EVA or petrochemical based LLDPE, and Emission factorBlend is the calculated emission for the blended ethylene-based polymer composition in kg CO₂/kg blended ethylene-based polymer composition. In one or more embodiments, blended polymer compositions in accordance with the present disclosure may have an Emission Factor as calculated according to Eq. 1 that is less than 1.0 kg CO₂/kg polymer composition. In some embodiments, polymer compositions may have an Emission Factor as calculated according to Eq. 1 in the range of range of −1.0 to 1.0 kg CO₂/kg blended polymer composition. While a range of Emission Factors are presented, it is envisioned that the Emission Factor may be approximately 0 or less negative than −1 in some embodiments, depending on the available starting materials and application requirements of the final polymer composition. For example, in one or more embodiments, the Emission Factor may have a lower limit of any of −1.0, −0.8, −0.6, −0.4, −0.2 or −0.1, and an upper limit of any of 0.1, 0.2, 0.4, 0.6, 0.8, or 1.0, where any lower limit can be used in combination with any upper limit.

As disclosed herein, the Emission Factor of polymer compositions may be calculated according to the international standard ISO 14044:2006-“ENVIRONMENTAL MANAGEMENT—LIFE CYCLE ASSESSMENT—REQUIREMENTS AND GUIDELINES”. The boundary conditions consider the cradle to gate approach. Numbers are based on peer reviewed LCA ISO 14044 compliant study and the environmental and life cycle model are based on SimaPro® software. Ecoinvent is used as background database and IPCC 2013 GWP100 is used as LCIA method.

Upon blending the PCR and virgin resin, in one or more embodiments, the blended ethylene-based polymer composition may have a melt index measured according to ASTM D1238 at 190° C./2.16 kg ranging from 0.10 to 1.5 g/10 min. In particular, the melt index may have a lower limit ranging from any of 0.10, 0.20, 0.25, 0.30, to 0.40 g/10 min to an upper limit of any of 0.40, 0.60, 1, or 1.5 g/10 min, where any lower limit can be used in combination with any upper limit.

Upon blending the PCR and virgin resin, in one or more embodiments, the ethylene-based polymer composition may have density measured according to ASTM D 792 greater than.0.945 g/cm³. In particular, the density may have a lower limit of any of 0.945, 0.950, or 0.960 g/cm³.

Upon blending the PCR and virgin resin, in one or more embodiments, the ethylene-based polymer composition may have an environmental stress cracking resistance, measured according to ASTM D 1693 Condition B that is greater than 10 hours to 50% failure. In particular, the environmental stress cracking resistance may be greater than 10, 12, 15, or 20 hours to 50% failure.

Upon blending the PCR and virgin resin, in one or more embodiments, the ethylene-based polymer composition may have an environmental stress cracking resistance, measured according to ASTM D 1693 Condition C that is greater than 20 hours to 50% failure. In particular, the environmental stress cracking resistance may be greater than 20, 25, or 30 hours to 50% failure.

Upon blending the PCR and virgin resin, in one or more embodiments, the ethylene-based polymer composition may have an Izod impact strength at 23° C., as measured according to ASTM D 256 (using a 3 mm thickness compression molded plaques prepared according to ASTM D4703), of at least 50 J/m. In particular, the izod impact strength may be greater than 50, 60, 80, 100 or even 120 J/m.

Upon blending the PCR and virgin resin, in one or more embodiments, the ethylene-based polymer composition may have a flexural modulus at 1% secant, as measured according to ASTM D 790 (using a 3 mm thickness compression molded plaques prepared according to ASTM D4703), ranging from about 800 to 1700 MPa. In particular, the flexural modulus at 1% secant may have a lower limit ranging from any of 800, 850, 900 or 1000 MPa to an upper limit of any of 1100, 1200, 1400, 1500 or 1700 MPa, where any lower limit can be used in combination with any upper limit.

In one or more embodiments, the blended ethylene-based polymer composition forms a middle layer of the multilayer article. However, it is also envisioned that the blended ethylene-based polymer composition forms a single layer structure or an inner or outer layer of a multi-layer article. Further, as mentioned below, one type of blow molding that may be used in accordance with the present disclosure includes, but is not limited to foam blow molding. Thus, in addition to the virgin HDPE and/or LLDPE and/or LDPE and/or EVA (all of which are optionally biobased) and PCR, the ethylene-based polymer composition may optionally also include at least one blowing agent. In such embodiments, the foamed layer may form the middle layer, in particular, and be formed from the blended polyethylene compositions disclosed herein.

In one or more embodiments, the at least one blowing agent comprises at least one physical blowing agent and/or at least one chemical blowing agent. In particular embodiments, the physical blowing agent is used in combination with a chemical blowing agent.

In one or more embodiments, the at least one blowing agent is in an amount ranging from 0.01 to 10 wt %. Thus, when forming the foamed layer, the ethylene-based polymer composition includes HDPE and/or LDPE and/or LLDPE and/or EVA in an amount ranging from 1 to 85 wt %; PCR in an amount ranging from 15 to 99 wt %; and at least one blowing agent in an amount ranging from 0.01 to 10 wt %.

Blowing agents in accordance with the present disclosure include chemical blowing agents that decompose at polymer processing temperatures, releasing the blowing gases such as N₂, CO, CO₂, and the like.

Physical blowing agents may include volatile organic solvents such as chlorofluorocarbons, hydrocarbons such as propane, n-butane, isobutane, n-pentane, isopentane, cyclopentane, n-hexane, isohexane, cyclohexane, alcohols such as ethanol and methanol, and gases such as nitrogen, carbon dioxide, carbon monoxide, and other inorganic blowing agents.

Examples of chemical blowing agents may include organic blowing agents, including hydrazines such as toluenesulfonyl hydrazine, hydrazides such as oxydibenzenesulfonyl hydrazide, diphenyl oxide-4,4′-disulfonic acid hydrazide, and the like, nitrates, azo compounds such as azodicarbonamide, cyanovaleric acid, azobis(isobutyronitrile), and N-nitroso compounds and other nitrogen-based materials, and other compounds known in the art.

Inorganic chemical blowing agents may include carbonates such as sodium hydrogen carbonate (sodium bicarbonate), sodium carbonate, potassium bicarbonate, potassium carbonate, ammonium carbonate, and the like, which may be used alone or combined with weak organic acids such as citric acid, lactic acid, or acetic acid.

In one or more embodiments, a physical blowing agent is used in combination with at least one foam nucleating agent. In such embodiments, the ethylene-based polymer composition further comprises at least one foam nucleating agent in an amount ranging from 0.01 to 10 wt %.

Examples of suitable foam nucleating agents include inorganic fillers such as carbon black, graphite, talc, silica, TiO2, calcium carbonate and combinations thereof. Suitable organic nucleating agents include an amide, an amine and/or an ester of a saturated or unsaturated aliphatic (C10-C34) carboxylic acid.

In addition to the above described components, it is also envisioned that the ethylene-based polymer composition (as well any layer of the article) may also include least one additive selected from antioxidants, optical brightener, processing aids, coloring agents, internal plasticizers, external plasticizers, foam nucleating agents, crystallization nucleating agents, superficial modifiers, neutralizing agents, and anti-static agents, or other types of additives.

Blow Molded Article and Methods Forming Article

Embodiments of the present disclosure encompass the production of blow molded articles such as packages, bottles, drums among others. As mentioned above, embodiments of the present disclosure further encompass foam blow molded articles that have at least one layer formed from the aforementioned blended ethylene-based polymer composition. Such ethylene-based polymer composition may, in particular embodiments, be present in the middle layer (optionally foamed), but can also be present in an inner or outer layer alone or in combination with multiple layers being formed from such blended ethylene-based polymer composition. In particular embodiments, each layer of the multi-layer article is formed from the blended ethylene-based polymer composition, with the middle layer optionally being foamed. Other embodiments may use one or two layers formed from virgin resin in combination with the blended composition in at least one of the other layers, while other embodiments may use one or two layers formed from PCR in combination with the blended composition in at least one of the other layers. For example, virgin resins (optionally biobased) may form the inner and outer layer while the middle layer (optionally foamed) is formed from the blended polymer composition. However, it is intended that any combination of layers may be formed in accordance with the present disclosure, for example, where the blended composition is present in a layer other than the middle layer.

Further, as discussed above, in one or more embodiments, virgin resin present in the article may be biobased HDPE, LLDPE, LDPE, and/or EVA. Such biobased resins may be present in any one of the layers (or all of the layers) either with 100% virgin content or in a blended composition (i.e., there being no virgin petrochemical resin being present). In a particular construction, the inner and outer layer may be formed from virgin biobased HDPE, LLDPE, LDPE, and/or EVA, while the middle foamed layer is formed from the blended composition (which itself is a blend of PCR with a virgin biobased resin). Thus, when included in one or more of the ethylene-based polymer compositions, the blow molded article may exhibit a biobased carbon content as determined by ASTM D6866-18 Method B of at least 5%. In particular, the blow molded article may include a biobased carbon content that has a lower limit of any of 5%, 10%, 25%, 40%, 50%, 75%, and 95% where any lower limit may be combined with any upper limit.

The ethylene-based polymer composition may be formed by blending (such as by dry blending or melt blending) PCR with a virgin resin (HDPE and/or LLDPE and/or LDPE and/or EVA, which may all be biobased), and in particular embodiments, the amounts selected for blending may be selected based on consideration of reduction of CO₂ emissions, as described above to have an Emission Factor less than or equal to 1.0 kg CO₂/kg of the ethylene-based polymer composition.

The blow molded articles of the present disclosure maybe formed by one of extrusion blow molding, injection blow molding, injection stretch blow molding and foam blow molding.

In injection blow molding, a hot preform or parison is injected into a mold, and a blowing nozzle may be inserted into the parison, through which an amount of pressurized air may blown into the parison, forcing the parison to take the shape of the mold. Once cooled and solidified, the article may be released and finished to remove excess material. Conversely, in extrusion blow molding, the parison may be extruded downward and captured between two halves of a mold that is closed when the parison reaches proper length.

The ISBM process of one or more embodiments may comprise at least an injection molding step and a stretch-blowing step. In the injection molding step a polyethylene-based resin composition is injection molded to provide a preform. In the stretch-blowing step the preform is heated, stretched, and expanded through the application of pressurized gas to provide an article. The two steps may, in some embodiments, be performed on the same machine in a one-stage process. In other embodiments, the two steps may be performed separately in multiple stages.

In foam blow molding, the ethylene-based polymer composition may thusly be co-extruded, depending on the final selection of the composition of each of the layers, to form a parison. The extruder forming the middle layer of the multi-layer extrudate may provide for the injection of a physical blowing agent into the extruder, or when a chemical blowing agent is used, the chemical blowing agent may be mixed with the polymer being fed into the extruder. In forming the three-layer article of the present disclosure, three extruders may be used, and a blowing agent is only fed into to the extruder forming the middle layer which will become the foamed layer. Gas, either injected into the extruder or formed through thermal decomposition of a chemical blowing agent in the melting zone of the extruder. The gas (irrespective of the source of the gas) in the polymer forms into bubbles that distribute through the molten polymer. Upon eventual solidification of the molten polymer, the gas bubble result in a cell structure or foamed material.

The parison extruded from the machine head may be captured by a water cooled mold, and a blowing nozzle may be inserted into the parison, through which an amount of pressurized air may blown into the parison, forcing the parison to take the shape of the mold. Once cooled and solidified, the article may be released and finished to remove excess material.

While the above describes several ways in which blow molding may be achieved, it is also understood that there is no limitation on the particular manner in which the blow molding may occur.

Upon formation of the article, in one or more embodiments, a foam blow molded article exhibits an Expansion Ratio (ER) ranging from 1 to 4, wherein the ER is determined according to the equation ER=ρ(1)/ρ(2), wherein ρ(1) is the density of the parison without blowing agents measured according to ASTM D 792 and ρ(2) is the density of the parison foamed using blowing agents measured according to ASTM D 792.

### EXAMPLES

In the following example, an ethylene-based polymer composition comprising 70 wt % of biobased HDPE and 30 wt % of PCR were prepared and extrusion blow molded into monolayer 1 L bottles in order to assay for the properties as disclosed herein. Table 1 presents the materials used for the formulation of the ethylene-based polymer composition.

TABLE 1
Materials used on the preparation of a blow molded article

| | | Test | | |
|---|---|---|---|---|
| Material | Property | Method | Value | Unity |
| Biobased | Melt Index (190° C./2.16 kg) | D 1238 | 0.34 | g/10 min |
| HDPE - | Melt Index (190° C./21.6 kg) | D 1238 | 28 | g/10 min |
| SGF4950 | Density | D 792 | 0.956 | g/cm³ |
| available by | Tensile strength at yield^{1,a} | D 638 | 30 | MPa |
| Braskem | Tensile strength at break^{1,a} | D 638 | 30 | MPa |
| | Flexural modulus at 1% secant^{1,b} | D 790 | 1350 | MPa |
| | Shore D Hardness^{2,c} | D 2240 | 63 | Shore D |
| | Environmental Stress Cracking resistance 10% | D 1693 (B) | 40 | h/F50 |
| | IGEPAL^{1,a} | | | |
| | Environmental Stress Cracking resistance 100% | D 1693 (C) | 70 | h/F50 |
| | IGEPAL^{1,a} | | | |
| | Deflection Temperature under Load at 0.455 MPa^{1,b} | D 648 | 70 | ° C. |
| | Vicat Softening Temperature at 10N^{1,b} | D 1525 | 127 | ° C. |
| PCR | Melt Index (190° C./2.16 kg) | D 1238 | 0.28 | g/10 min |
| (HDPE- | Melt Index (190° C./21.6 kg) | D 1238 | 35.92 | g/10 min |
| PCR) | Density | D 792 | 0.969 | g/cm³ |
| | Flexural modulus at 1% secant^{1,b} | D 790 | 1260 | MPa |
| | Izod impact strength at 23° C.^{1,b} | D 256 | 40.5 | MPa |
| | Environmental Stress Cracking resistance 10% | D 1693 (B) | 14 | h/F50 |
| | IGEPAL^{1,a} | | | |
| | Environmental Stress Cracking resistance 100% | D 1693 (B) | 38 | h/F50 |
| | IGEPAL^{1,a} | | | |
| Ethylene- | Melt Index (190° C./2.16 kg) | D 1238 | 0.27 | g/10 min |
| based | Melt Index (190° C./21.6 kg) | D 1238 | 26.6 | g/10 min |
| polymer | Density | D 792 | 0.962 | g/cm³ |
| composition | Environmental Stress Cracking resistance 10% | D 1693 (B) | 15 | h/F50 |
| | IGEPAL^{1,a} | | | |
| | Environmental Stress Cracking resistance 100% | D 1693 (C) | 43 | h/F50 |
| | IGEPAL^{1,a} | | | |
| | Izod impact strength at 23° C.^{1,b} | D 256 | 76.8 | J/m |
| | Flexural modulus at 1% secant^{1,b} | D 790 | 1099 | MPa |

¹Test specimens from compression molded plaque according to ASTM D4703.
Plaque Thickness:
^{a}2 mm
^{b}3 mm
^{c}6 mm

A life cycle analysis of the steps involved in the production of the biobased HDPE from sugarcane and PCR, with Emission Factors calculated for each step is shown in Table 2 (HDPE) and Table 3 (PCR).

TABLE 2
Sample calculation of an Emission Factor
for the production of a biobased HDPE

| | | Emission Factor |
|---|---|---|
| Impact Category | Resin | (kg CO₂eq/kg resin) |
| Sugarcane | Agricultural operations | 0.91 |
| production | Land use change credits | −1.10 |
| | CO₂ Uptake | −3.14 |
| | Subtotal | −3.33 |
| Ethanol | Ethanol production | 0.03 |
| Production | Bagasse burning | 0.16 |
| | Electricity cogeneration | −1.17 |
| | credits | |
| | Subtotal | −0.98 |
| Biobased HDPE | Ethanol transport | 0.46 |
| Production | Industrial Operations | 0.76 |
| | (Ethylene and PE) | |
| | Subtotal | 1.22 |
| | TOTAL | −3.09 |

TABLE 3
Associated Emission Factors for PCR

| | Emission Factor |
|---|---|
| PCR Source | (kg CO₂eq/kg resin) |
| Post-consumer PE | 1.05 |
| Post-consumer Sorting | 0.00286 |
| Collection and transport | 0.0218 |
| PE Flake Production | 0.0224 |
| Wastewater treatment | 0.00652 |
| Pellets Production | 0.0772 |
| Final transport to Sao Paulo - PCR | 0.0191 |
| Total | 1.20 |

Emission factor of the ethylene-based polymer composition was calculated according to equation (1) below, resulting in an emission factor of −0.087 kg CO₂eq/kg resin, i.e., a near zero carbon emission composition, which translates into an environmental friendly composition to be used in blow-molded applications.

P1_{Biobased}·Emission factor_{P1Biobased}+P2_{Recycled}·Emission factor_{P2Recycled}+P3_{Petro}·Emission factor_{P3Petro}=Emission factor_{blend} (1)
P1_{Biobased}=30 wt %; P2_{Recycled}=70 wt %; P3_{Petro}=0 wt %
Emission factor_{P1Biobased}=−3.09 kg CO₂eq/kg resin; Emission factor_{P2Recycled}=+1.20 kg CO₂eq/kg resin

Monolayer bottles of 1 L volume were produced through extrusion blow molding process. A comparative example of bottles produced using only a virgin resin (HDPE-SGF4950) and an inventive bottle comprising the ethylene-based polymer composition of Table 1 were assayed for environmental stress cracking resistance (ESCR) according to ASTM D 1693 with 10% Igepal. Table 4 summarizes the results observed.

TABLE 4
ESCR results for bottles produced

| Application | Material | ESCR |
|---|---|---|
| Bottles 1 L - | SGF4950 | 113 h |
| EBM Process | Ethylene-based | 135 h |
| | polymer composition | |

As can be observed by the ESCR results from Table 2, bottles produced with the ethylene-based polymer composition of the present disclosure has an ESCR near to the bottles produced with a virgin material, and produced with a recycled resin with near zero CO₂ emission.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A blow molded article, comprising:
at least one layer comprising a blended ethylene-based polymer composition, the blended ethylene-based having a PCR content varying from greater than 10 wt % to less than 95 wt % and a virgin resin content varying from greater than 5 to less than 90 wt %, wherein the virgin resin is selected from HDPE, LLDPE, LDPE, EVA, or combinations thereof,
wherein the PCR and virgin content are selected so that the blended ethylene-based polymer composition has an Izod impact strength at 23° C., as measured according to ASTM D 256, of at least 50 J/m, and/or a flexural modulus at 1% secant, as measured according to ASTM D 790, ranging from about 800 to 1700 MPa.

2. (canceled)

3. The blow molded article of claim 1, wherein the blended ethylene-based polymer composition comprises a virgin biobased HDPE and/or a virgin biobased LDPE and/or a virgin biobased EVA and/or a virgin biobased LLDPE; and wherein the blended ethylene-based polymer compositions exhibits a biobased carbon content as determined by ASTM D6866-18 Method B of at least 5%.

4. The blow molded article of claim 3, wherein the wt % of each component in the blended ethylene-based polymer composition is selected such that the blended ethylene-based polymer composition exhibits an Emission Factor_{Blend} in the range of −1.0 to 1.0 kg CO₂/kg of the blended ethylene-based polymer composition, as determined according to the formula:
P1_{Biobased}·Emission factor_{P1Biobased}+P2_{Recycled}·Emission factor_{P2Recycled}+P3_{Petro}·Emission factor_{P3Petro}=Emission factor_{blend};
wherein P1_{Biobased} is the weight percentage of the biobased HDPE, biobased LDPE, or biobased EVA, or biobased LLDPE, P2_{Recycled} is the weight percent of the PCR, P3_{Petro} is the weight percent of the virgin petrochemical based HDPE, petrochemical based LDPE, petrochemical based EVA or petrochemical based LLDPE; Emission factor_{P1Biobased} is the calculated emission for the biobased HDPE, biobased LDPE, or biobased EVA, or biobased LLDPE in kg CO₂/kg PE, Emission factor_{P2Recycled} is the calculated emission for the PCR in kg CO₂/kg PE, Emission factor_{P3Petro} is the calculated emission for the the virgin petrochemical based HDPE, petrochemical based LDPE, petrochemical based EVA or petrochemical based LLDPE, and Emission factor_{Blend} is the calculated emission for the blended ethylene-based polymer composition in kg CO₂/kg blended ethylene-based polymer composition.

5. (canceled)

6. The blow molded article of claim 1, wherein the blended ethylene-based polymer composition comprises a virgin HDPE and/or virgin LDPE and/or virgin EVA and/or virgin LLDPE in an amount ranging from 5 to 90 wt % and PCR in an amount ranging from 10 to 95 wt %, based on the total weight of the blended ethylene-based polymer composition.

7. The blow molded article of claim 1, wherein the blended ethylene-based polymer composition comprises a virgin HDPE in an amount ranging from 2.4 wt % to 59.3 wt %.

8. (canceled)

9. The blow molded article of claim 1, wherein the HDPE and/or LDPE and/or LLDPE in the blended ethylene-based polymer compositions has a melt index measured according to ASTM D1238 at 190° C./2.16 kg ranging from 0.1 to 5 g/10 min and/or a melt index measured according to ASTM D1238 at 190° C./21.6 kg ranging from 1 to 55 g/10 min.

10. (canceled)

11. The blow molded article of claim 1, wherein the HDPE in the blended ethylene-based polymer composition has a density measured according to ASTM D 792 greater than 0.940 g/cm³ and the LDPE and/or the LLDPE in the blended ethylene-based polymer composition has a density measured according to ASTM D 792 ranging from 0.915 to 0.930 g/cm³.

12. (canceled)

13. The blow molded article of claim 1, wherein the EVA in the blended ethylene-based polymer composition has a melt index measured according ASTM D1238 at 190° C./2.16 ranging from 0.2 to 25 g/10 min and a vinyl acetate content as determined by ASTM D5594 ranging from 5 to 40 wt % of the EVA.

14. The blow molded article of claim 1, wherein the HDPE and/or LDPE and/or EVA and/or LLDPE in the blended ethylene-based polymer composition has at least one of:
a flexural modulus at 1% secant, measured according to ASTM D 790 ranging from 200 to 1700 MPa;
a Shore D hardness, measured according to ASTM D 2240, ranging from 45 to 70 Shore D;
a tensile strength at yield, measured according to ASTM D638, ranging from about 10 to 45 MPa;
a tensile strength at break, measured according to ASTM D638, ranging from about 5 to 45 MPa;
a heat deflection temperature, measured according to ASTM D648 under a load at 0.455 MPa, ranging from 40 to 80° C.;
a Vicat softening temperature, measured according to ASTM D1525 at ION, greater than 80° C.; or
combinations thereof.

15. The blow molded article of claim 1, wherein the HDPE and/or LDPE and/or LLDPE in the blended ethylene-based polymer composition has an environmental stress cracking resistance, measured according to ASTM D 1693 Condition B, that is greater than 8 hours to 50% failure.

16. (canceled)

17. (canceled)

18. (canceled)

19. (canceled)

20. (canceled)

21. (canceled)

22. (canceled)

23. The blow molded article of claim 1, wherein the PCR in the blended ethylene-based polymer composition has a melt index measured according to ASTM D1238 at 190° C./2.16 kg ranging from 0.1 to 1 g/10 min.

24. The blow molded article of claim 1, wherein the PCR in the blended ethylene-based polymer composition has a density measured according to ASTM D 792 greater than 0.940 g/cm³.

25. The blow molded article of claim 1, wherein the PCR is a high density PCR obtained from blow molded articles selected from lubricant oil bottles.

26. The blow molded article of claim 1, wherein the blended ethylene-based polymer composition has a melt index measured according to ASTM D1238 at 190° C./2.16 kg ranging from 0.1 to 1.5 g/10 min.

27. The blow molded article of claim 1, wherein the blended ethylene-based polymer composition has a density measured according to ASTM D 792 greater than 0.945 g/cm³.

28. The blow molded article of claim 1, The blow molded article of any of the above claims, wherein the blended ethylene-based polymer composition has an environmental stress cracking resistance, measured according to ASTM D 1693 Condition B, that is greater than 10 hours to 50% failure.

29. The blow molded article of claim 1, wherein the blended ethylene-based polymer composition has an environmental stress cracking resistance, measured according to ASTM D 1693 Condition C, that is greater than 20 hours to 50% failure.

30. A method for preparing the blow molded article of claim 1, the method comprising:
dry blending or melt blending the PCR and the virgin resin selected from HDPE, LDPE, EVA, LLDPE or combinations thereof to form the blended ethylene-based polymer composition; and
blow molding the article of claim 1.

31. (canceled)

32. The method of claim 30, wherein the blow molding is selected from extrusion blow molding, injection blow molding, injection stretch blow molding and foam blow molding.

33. (canceled)
